(19) United States
(12) Patent Application Publication
(10) Pub. No.: US 2023/0397521 A1
(43) Pub. Date: Dec. 14, 2023

(54) AUTOMATED AND DIRECTED DATA GATHERING FOR HORTICULTURAL OPERATIONS WITH ROBOTIC DEVICES

(71) Applicant: iUNU, Inc., Seattle, WA (US)

(72) Inventors: Adam Phillip Takla GREENBERG, Seattle, WA (US); Ethan Victor TAKLA, Seattle, WA (US)

(21) Appl. No.: 18/208,837

(22) Filed: Jun. 12, 2023

Related U.S. Application Data
(60) Provisional application No. 63/351,792, filed on Jun. 13, 2022.

(51) Int. Cl. A01B 79/00; A01B 79/02; G06V 20/10; G06V 20/17; G06V 10/70; G06T 7/00

(52) U.S. Cl. CPC A01B 79/005; A01B 79/02; G06V 20/188; G06V 20/17; G06V 10/70; G06T 7/0012; G06T 2207/10032; G06T 2207/20081; G06T 2207/30188

(57) ABSTRACT

Disclosed are techniques for providing automated scouting of a grow operation in order to facilitate early detection and treatment of various conditions. Such techniques may comprise receiving sensor data from a number of sensors within a grow operation, determining current data values for a number of attributes to be associated with locations within the grow operation, identifying one or more regions within the grow operation potentially associated with a condition, providing instructions to at least one robotic device to perform a scouting operation of the one or more regions, and determining, based on information collected during the scouting operation, whether the condition is present in the one or more regions.

### CROSS-REFERENCE TO RELATED APPLICATIONS

This application claims the benefit of U.S. Provisional Application No. 63/351,792, filed Jun. 13, 2022, and titled “AUTOMATED AND DIRECTED SCOUTING OF HORTICULTURAL OPERATIONS WITH ROBOTIC DEVICES,” which is herein incorporated by reference in its entirety.

### BACKGROUND

Modern industrial horticultural operations include not merely the planting, cultivation, and harvesting of plants, but performing those operations with multiple plants, conditions, greenhouses, grow operations, and people, all in different geographic locations. Accordingly, collecting and marshaling of this information towards a coherent and effective horticultural operation can be difficult.

A number of different problematic conditions (e.g., diseases, pest infestations, malnutrition, etc.) may impact various plants within a grow operation. When plants are affected by such conditions, early detection is key to effective treatment. Generally, a master grower regularly collects information about a horticultural operation, identifies problematic conditions, identifies solutions for those problems and applies them for remediation. However, when a grow operation is sufficiently large, it may be difficult to dedicate sufficient resources to early detection of problematic conditions.

### SUMMARY

Techniques are provided herein for automatic detection of various conditions that may impact a plant or group of plants within a grow operation. In such techniques, information about a grow operation is obtained from a number of sensors distributed throughout the grow operation. The information is used to generate one or more data distributions mapping current attribute data values to locations. A set of attribute data value ranges is then retrieved for each condition to be detected within the grow operation. One or more regions of the grow operation can then be determined for which the current attribute data values are each within the respective ranges of the set of attribute data value ranges for the condition. Once one or more such regions have been identified, robotic devices may be assigned data gathering tasks throughout the identified region in order to confirm or disprove the existence of the condition. A condition may be associated with a pattern recognition technique including machine-learning based techniques, and such techniques may be used to identify regions and assign data gathering tasks throughout the identified regions as well as to confirm or disprove the existence of the conditions.

A condition may include any suitable status, beneficial, neutral, or harmful, that impacts a plant or group of plants. In some cases, a condition may be a disease, infection, or infestation that has developed, or has a high likelihood of developing, in the plant or group of plants. In some cases, a condition may be a status caused by environmental factors, such as heat stroke caused by excessive exposure to high temperatures or malnutrition caused by insufficient nutrients in the soil. In some cases, a condition may be a lifecycle stage that the plant or plants are currently in. For example, the condition may be that the plant is flowering or fruiting.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 depicts an exemplary context diagram illustrating a system for implementation in horticultural grow operations to facilitate automated unmanned aerial vehicle data gathering in accordance with at least some embodiments;

FIG. 2 is a block diagram showing various components of a system architecture that may be implemented to perform at least a portion of the functionality in accordance with at least some embodiments;

FIG. 3 illustrates an example of an unmanned aerial vehicle for use in horticultural operations in accordance with at least some embodiments;

FIG. 4 depicts a block diagram illustrating an example process for monitoring and checking for conditions in a grow operation in accordance with at least some embodiments;

FIG. 5 depicts a graphical illustration of a process for identifying a region of a grow operation and performing a data gathering operation of that region in accordance with at least some embodiments;

FIG. 6 depicts examples of information that may be presented via a graphical user interface implemented in accordance with at least some embodiments; and

FIG. 7 depicts a flow diagram illustrating a process for providing automated scouting of regions to detect various conditions in accordance with at least some embodiments.

### DETAILED DESCRIPTION

Described herein are techniques for providing early detection and treatment of various conditions, such as pest infestations, diseases/infections, malnutrition, etc. In embodiments, sensor data is received from a number of sensors distributed throughout a grow operation and used to calculate current attribute data values by location. These current attribute data values may then be compared to attribute value ranges for a variety of potential conditions to identify regions in which the potential condition may be present. Upon identifying such a region, a data gathering operation of the region may be automatically executed by a robotic device in order to determine whether or not the condition is actually present in the region. A condition may be associated with a pattern recognition technique including machine-learning based techniques, and such techniques may be used to identify regions and assign scouting tasks throughout the identified regions as well as to confirm or disprove the existence of the conditions. Such data gathering may be automated at least in part (“automated data gathering”). Alternatively, or in addition, scouting may be at least in part directed by a user (“directed data gathering”). “Data gathering” is distinguished from “scouring” and “crop registration,” with “data gathering” the more generic term. “Scouting” involves a robotic device progressing to a designated location to verify or detect a suspected condition. “Crop registration” involves revisiting designated crop plants repeatedly over time to verify or detect a condition. The suspected condition may have, for example, have been detected during data gathering. For clarity, the scouting example is used consistently throughout this description. However, as will be apparent to one of skill in the art, suitable examples can be applied to data gathering and/or crop registration.

Embodiments of the disclosure may provide for several benefits over conventional systems. For example, embodiments of the disclosure may facilitate early detection and treatment of problematic conditions in an automated manner and without significant costs in resources. In embodiments of the disclosed system, sensor data can be continuously monitored to detect the presence of a variety of different conditions as those conditions may present themselves. Those conditions may then be treated before they become serious, resulting in reduced risk of catastrophic crop failures for a grow operation.

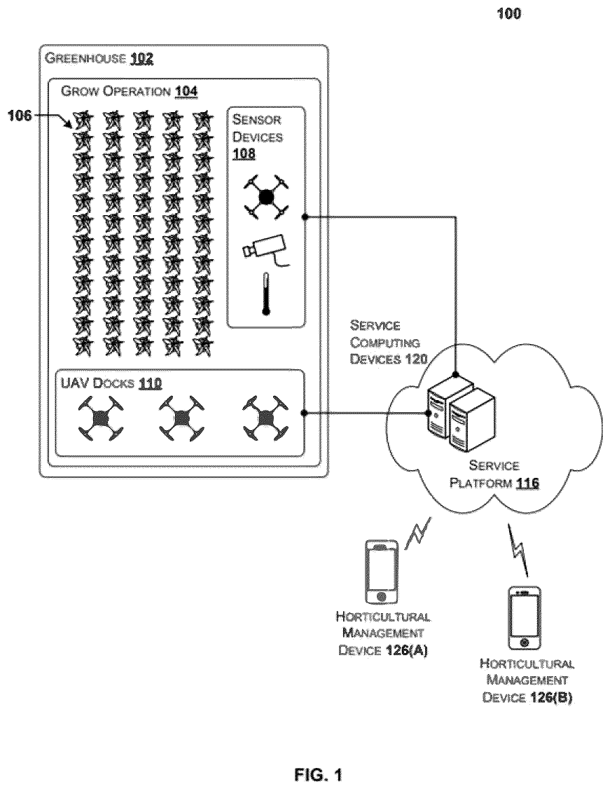

FIG. 1 depicts an exemplary context diagram illustrating a system 100 for implementation in horticultural grow operations to facilitate automated unmanned aerial vehicle (UAV) data gathering in accordance with embodiments. A horticultural operation may cover one or more locations, such as a greenhouse 102. A greenhouse 102 may have one or more grow operations 104 each with one or more plant 106. The grow operation may include one or more sensor devices 108 as well as one or more UAV docks 110.

The individual greenhouses 102 and/or grow operations 104 can comprise an operation zone. In various embodiments, each grow operation 104 can comprise one or more operation zones. Additionally, two or more operation zones can partially overlap. The plants 106 can comprise a single type of plant or multiple types of plants. In various embodiments, a single grow operation 104 may include multiple plants in different locations/greenhouses 102. For the purposes of this disclosure, a grow operation 104 is any suitable logical or a discrete group of plants 106 that are similarly situated such that the cultivation of each plant in the group is substantially similar.

One or more sensor devices 108 are located at, and throughout, each grow operation 104. In various embodiments, the sensor devices 108 include any suitable electronic device capable of collecting information about plants or an environment in which plants are situated, such as but not limited to image sensors or image capture devices (e.g., cameras, near infrared, and hyperspectral) that can be used to capture images of plants 106 (or discrete group of plants). Sensor devices 108 may include any suitable environmental sensor, such as but not limited to a temperature sensor (e.g., a thermometer), light sensor, pH sensor, humidity sensor, or CO₂ sensor.

In some embodiments, each individual plant may have one or more dedicated image capture devices. The image capture device may be a digital video camera or may be a still image camera configured to capture images periodically and/or on demand. The image capture device may also comprise a moving camera device. For example, a camera device may be located on an unmanned aerial vehicle (UAV), rails, or other suitable robotic transport.

Exemplary image capture devices may be capable of capturing an image in one or more light spectrums and in an automated or non-automated fashion. Such image capture devices can include, but are not limited to, cameras on smart phones, tablets, security cameras, web cameras, scientific cameras, industrial cameras, or Raspberry Pi Cameras. Imaging devices may contain wireless hardware that can include but are not limited to 4G/5G/LTE, Wi-Fi, Bluetooth, NFC, LoRa, or Zigbee that can be used to transmit information back to one or more service computing devices 120, or to other image capture devices. In some embodiments, sensor devices may contain the necessary hardware on-board to carry out all image and data processing, so as to create a decentralized processing network. In some embodiments, the sensor device may contain a lighting source used during image capture that helps normalize the lighting variances commonly experienced in indoor or outdoor growing settings. In some cases, more than one image capture device may be used to collect images of plants 106 so as to provide better imaging quality or 3D information.

In some embodiments, the sensor devices 108 may further include one or more robotic devices configured to traverse the grow operation and capture images periodically and/or on demand. Such a robotic device (e.g., an unmanned aerial vehicle (UAV)) may include its own image capture device (e.g., a camera). The robotic device may have an onboard application programming interface (API) enabling programmatic control. Alternatively, the robotic device may be networked thereby enabling remote control. In some embodiments, the robotic device may be configured to traverse a route provided by a service platform 116 and/or perform one or more tasks indicated in a workflow.

A sensor device 108 may be positioned at any suitable distance to any suitable plant or plants, using any means of mounting, such that an image of plant or plants can be collected by the included image capture device. A desirable distance from the lens of the camera to the plant or plants can be determined by understanding the minimum focal distance of the camera, the minimum distance required to keep the entire plant or plants in the field of view of the camera and aiming to maximize the pixels per spatial unit at the plane or planes associated with the plant.

In some embodiments, one or more UAV docks 110 may be located throughout the grow operation. A UAV dock may be any suitable docking station for a robotic device (such as a drone or other UAV) that provides charging capabilities for that robotic device while it is between operations. In embodiments, the one or more UAV docks 110 act as a base of operations for one or more robotic devices capable of performing operations throughout the grow operation.

A service platform 116 may comprise a computing system in which at least a portion of the functionality described herein is implemented across one or more service computing devices 120. A service computing device 120 may be a physical dedicated server, a virtual machine, a portable/mobile computing device (e.g., smartphones, tablet, and laptops), and/or robotic devices. In the latter case, the service platform 116 may be implemented on a cloud, such that the service computing devices 120 represent a plurality of disaggregated servers that provide virtual application server functionality and virtual storage/database functionality. The disaggregated service computing devices 120 may be physical computer servers, which may have a processor, a memory, an I/O interface and/or a network interface. In some cases, the disaggregated service computing devices 120 are optimized for the functionality attributed to the service platform 116 as described herein. In some embodiments, the service platform 116 may be configured to receive sensor data from one or more sensor devices 108, identify one or more regions that may be impacted by a potential problematic condition, and organize automated scouting to the one or more regions. Thus, the image and data processing functionalities of the service platform 116 may be performed by computing devices that are located on-site at a facility (e.g., a greenhouse), and/or off-site, such as at a dedicated remote data processing center or via third-party cloud computing resources.

In various embodiments, multiple grow operations 104 may be managed via the service platform 116. As noted above, each grow operation 104 may include one or more sensor devices 108 to monitor plants 106 (and/or environmental conditions) within the grow operation 104. Thus, the service platform 116 can be operatively connected to, and/or communicate with, the one or more sensor devices 108. In some cases, the service platform 116 can additionally monitor and control the movement operations of one or more robotic devices (e.g., UAVs and/or track carriers) within the grow operation 104.

The service platform 116 may provide, without limitations, mission planning and/or safety oversight for several grow operations 104 concurrently using a number of sensor devices 108, wherein the grow operations 104 may not be near each other. The service platform 116 may include one or more cameras to monitor the operation of the one or more robotic devices within each respective grow operation 104, as well as the operation of the one or more robotic devices 108 while they are located outside of the grow operation (e.g., aisles, hallways, etc.) but within a greenhouse 102 or other target areas.

The horticultural management device 126 may be any suitable networked computing device, including mobile tablets over Wi-Fi and/or mobile tablets over a cellular network and/or laptop. The horticultural management device 126 may connect to the service platform 116, or directly to one or more components of the grow operation 104. For example, the horticultural management device 126 may connect to the sensor devices 108, UAV docks 110, and/or other interfaces associated with the grow operation 104. In some embodiments, the horticultural management device 126 is configured to present information received from the service platform 116 to an operator. In some cases, such information may include an indication of a problem one or more workflows configured to result in optimization of plant growth with respect to a specified attribute.

The illustrative computing system 100 may utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, and any suitable combination thereof.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

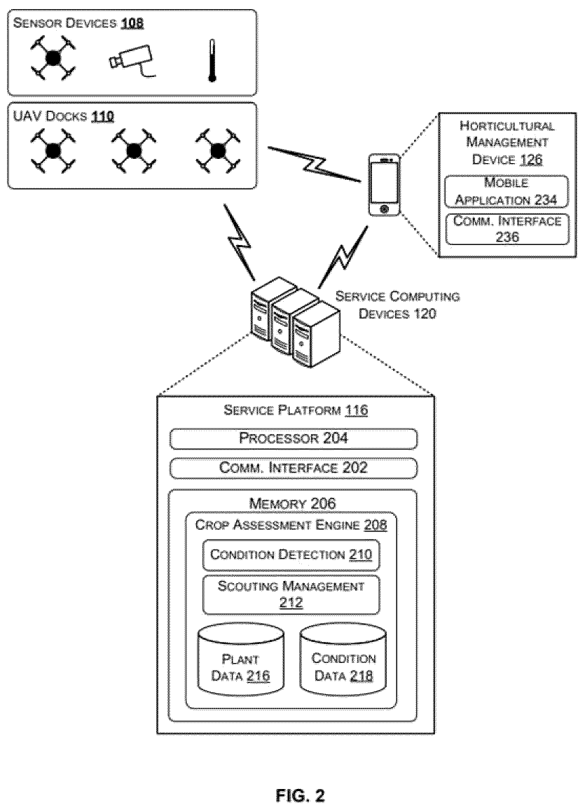

FIG. 2 is a block diagram showing various components of a system architecture that may be implemented to perform at least a portion of the functionality described herein. The system architecture may include a service platform 116 that comprises one or more service computing devices 120. As noted elsewhere, the service platform 116 may be in communication with one or more sensor devices 108, UAV docks 110, and/or one or more horticultural management devices 126.

The service platform 116 can include any suitable computing device configured to perform at least a portion of the operations described herein. The service platform 116 may be composed of one or more general purpose computers, specialized server computers (including, by way of example, PC (personal computer) servers, UNIX® servers, mid-range servers, mainframe computers, rack-mounted servers, etc.), server farms, server clusters, or any suitable other appropriate arrangement and/or combination. The service platform 116 can include one or more virtual machines running virtual operating systems, or other computing architectures involving virtualization such as one or more flexible pools of logical storage devices that can be virtualized to maintain virtual storage devices for the computer. For example, the service platform 116 may include virtual computing devices in the form of virtual machines or software containers that are hosted in a cloud.

The service platform 116 may include a communication interface 202, one or more processors 204, memory 206, and any suitable combination of hardware required to perform the functionality described herein. The communication interface 202 may include wireless and/or wired communication components that enable the service platform 116 to transmit data to and receive data from other networked devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any suitable method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the service platform 116 may implement functionality via one or more software modules and data stores. Such software modules may include routines, program instructions, objects, and/or data structures that are executed by the processors 204 to perform particular tasks or implement particular data types. The service platform 116 may include a crop assessment engine 208 configured to optimize crop growth for a specified attribute. Such a crop assessment engine 208 may include a number of components or modules. For example, the crop assessment engine 208 may include a condition detection module 210 configured to detect one or more conditions (e.g., problematic conditions) that impact plants within a region, and a scouting management module 212 configured to schedule and route scouting of robotic devices. Additionally, the crop assessment engine may maintain plant data 216 that includes information about plant types and locations located throughout a grow operation as well as condition data 218 that includes information about different types of conditions that may affect various plants.

The condition detection module 210 may be configured to, in conjunction with the processor 204, identify one or more regions of plants within a grow operation that may be affected by one or more conditions. In embodiments, various data values may be determined for the grow operation as a function of location. Such data values may be determined from sensors distributed throughout the grow operation and/or other suitable data streams or data bases such as grow element chain of custody and worker logs. For example, a distribution of temperature values may be generated from temperature data received from the sensor devices. In this example, temperature data for locations between sensors may be determined by extrapolation from data values collected by the respective sensors. Once data values have been determined for a distribution throughout a grow operation, a determination may be made as to whether any areas within the grow operation are indicative of a potential condition. In embodiments, the condition detection module 210 may identify one or more areas or regions for which various attribute data values fall within each of the ranges associated with a condition or conditions. In these embodiments, a line representing the edge of the area may be defined based on where the determined attribute data values are within the attribute data value ranges associated with the condition on one side of the line and outside the attribute data value ranges on the other side of the line.

In embodiments, one or more conditions may be associated with particular plant types. In other words, each different type of plant may be capable of being subject to a different set of conditions. For example, a particular type of pest infestation (e.g., a condition) may only impact certain species of plants. Each potential condition that may impact a plant may be associated with a range of attribute data values. In some cases, such a range may be representative of data values that are typically attributed to plants that have developed the condition. In some cases, such a range may be representative of data values that represent an environment in which the condition may develop. For example, a range of soil acidity values, a range of temperature values, and a range of humidity values may be associated with an environment in which a fungal infestation may develop.

In some cases, correlation of one or more conditions to ranges of attribute values may involve the use of a suitable trained machine learning model. For example, the condition detection module 210 may include any suitable convolutional neural network backbone (which can include but is not limited to EfficientNet, ResNet, Res2Net, ResNet-Xt, MobileNet, DarkNet, VGG16, VGG16/19), a transformer (deep learning model), graph neural network, or any other suitable type of machine learning model.

For example, a machine-learning model, such as a multi-layer perceptron, a transformer (deep-learning model), or a graph neural network may be “trained” by providing data values as “input values” related to environmental factors determined for one or more plant (e.g., pH levels, temperature over time, weather, etc.). Additionally, data values that indicate one or more conditions associated with a plant are provided as “output values”. Once trained, correlations can be identified by the machine learning model between the data values provided as input values and the data values provided as output values.

In some embodiments, the condition detection module 210 may derive at least a portion of the data values used in its analysis using one or more object detection modules/techniques. For example, images of crops may be used to determine data values associated with those crops. In this example, the images may show various plant characteristics, such as yellowing of leaves, amounts of stem, branch or leave growth, lack or presence of flowers, size and/or color of fruits, presence or absence of pests, etc. that may be detected and translated into attribute data values by the condition detection module 210. Exemplary object detection modules can include, but are not limited to, anchor-based modules, transformer modules, graph-based modules, fully convolutional anchor-free modules, or two stages approaches with region proposal networks and prediction modules as found in the R-CNN series object detectors. The method of object detection is not limited to just convolutional neural networks and can include any suitable machine learning algorithm or model used to interpret spatial data from an imaging sensor in any suitable subset of measurable light spectrum. Other methods include using pure attention-based networks in conjunction with any of the aforementioned object detection modules, or image transformers (which can include but are not limited to Image GPT from OpenAI). It should be noted that if the chosen method for object detection requires training, any suitable form of hinge loss, ranking loss, triplet loss, or contrastive loss can be used for training the classification module, which can significantly improve accuracy in fine-grained cases. In alternative embodiments, the functions performed by the condition detection module 210 may be performed by any suitable robotic device (e.g., a UAV) using an onboard processing module and/or comparable onboard software.

The scouting management module 212 may be configured to, in conjunction with the processor 204, schedule scouting of one or more areas identified as being potentially associated with a condition or conditions. In some embodiments, where multiple areas are identified as being associated with multiple conditions, the scouting management module may be configured to identify a scouting priority. For example, in some cases, each condition may be associated with a priority or ranking. In this example, areas associated with each condition may be assigned a priority associated with the condition. In some cases, a priority may be assigned to an area for scouting based on a type of plant or plants in that area, a current lifecycle stage of the plant or plants, a value (e.g., a dollar value) of the plant or plants, or any other suitable factor. Once the scouting management module 212 has determined priorities to be assigned to each of the areas to be scouted, a scouting schedule may be generated to cause each of those areas to be scouted by a robotic device (e.g., a UAV).

In some embodiments, the scouting management module 212 may perform time-based scheduling such that each of one or more robotic devices may traverse an area in a predefined or dynamic pattern at fixed or dynamic times during the day. For example, a predefined pattern may involve a robotic device being configured to scout an area at regular time intervals throughout the day, or scout multiple areas at corresponding times during the day such that all areas are scouted during the day. With the use of dynamic patterns, the timing of the scouting routes of the robotic devices may be dynamically scheduled throughout the day. For example, some areas may be at high risk for the occurrence of a specific condition as determined based on data continuously obtained from stationary sensors distributed at the various areas of the greenhouse. For example, a statistical analysis of the attribute data values obtained from the data may show that the risk of a specific condition occurring in an area or areas during a particular future time period (e.g., next week, next 10 days, 20 days, etc.) exceeds a risk value threshold. As such, the scouting management module 212 may dynamically plan scouting routes to scout the area or the areas until the risk value is assessed to be below the risk value threshold based on further data from the stationary sensors.

In some embodiments, the scouting management module 212 may schedule scouting of one or more areas based on inputted configuration parameters. In such embodiments, a grower may use a user interface of a computer (e.g., provided by a mobile application) to cause the scout management module 212 to initiate scouting of specific areas in an ad-hoc manner. For example, the grower may decide to send a robotic device to scout a specific area or areas based on inherent knowledge that the grower has acquired over many years regarding the grow operations in the areas.

In some embodiments, the scouting management module 212 may initiate scouting based on the existing environmental features or objects in an area that has known potential effect on conditions in the area. For example, an external wall of a greenhouse may make the outermost set of plants in a particular area of the greenhouse experience colder temperatures than plants that are in other areas further away from the wall, which may make the occurrence of a specific condition (e.g., pest infestation) in the particular area more likely than in the other areas. In such embodiments, the scouting management module 212 may use a database that contains information on environmental features or objects that impact the occurrence of corresponding conditions, i.e., making particular conditions more likely to occur in certain areas. Accordingly, the scouting management module 212 may treat certain high risk areas as being affected by certain conditions regardless of whether certain conditions actually exist in these areas, and schedule regular or dynamic scouting for these areas.

In some embodiments, the scouting management module 212 may initiate task-based scouting of certain areas. These areas may be areas in which certain known tasks that may lead to or are associated with the occurrence of corresponding conditions have been recently performed within a predetermined period of time. Such tasks may include a recent planting of new plants in an area, a movement of plants to the area from another area, a recent application of fertilizer in the area, a recent harvest of fruits from plants, and/or so forth. For example, an area heavily trafficked with workers may need scouting some number of days after the work occurred to check for an outbreak of disease. Workers may also perform actions on the plants that may make them more likely to experience a pest or disease. A task may that transitions a plant to a new phase of growth or movement to a new area may also increase the risk of pests or diseases as well. In such embodiments, the grower may report the completion of the tasks to the scouting management module 212 via the user interface. In turn, the scouting management module 212 may store the task completion data in a database. The scouting management module 212 may be configured to correlate each task completed with one or more potential conditions via a built-in correlation table. Subsequently, the scouting management module 212 may use the data in the database to dynamically schedule a robotic device to scout an area where a task is performed. In some embodiments, the scouting management module 212 may initiate scouting of certain areas based on historical data regarding the occurrence of conditions or performance of tasks in those areas. For example, the occurrences of a condition in an area that exceeds an occurrence frequency threshold (e.g., more than four times a year) during a predetermined past period of time (e.g., a previous two-year period) may trigger the scouting management module 212 to schedule scouting of the area by a robotic device at regular or dynamic intervals for a predetermined period of time. In another example, the recent completion of a particular type of task within a past period of time (e.g., the last month) may trigger the scouting management module 212 to schedule scouting of the area by a robotic device at regular or dynamic intervals for a predetermined period of time.

In some embodiments, the scouting management module 212 may conduct operations in a batched manner. Rather than attempt to collect data over time with respect to each and every location, zone, area, region, plot and/or plant, the scouting management module 212 may select a subset thereof (e.g., a statistically representative subset). Data over time may then be collected by consistently revisiting elements of the selected subset and analyzing changes of elements over time. A condition detected in this manner may trigger additional scouting, for example, of elements adjacent to the elements of the batch. Batched scouting can reduce scouting resource requirements including number of robotic devices and computing resources such as bandwidth and processing time.

The scouting management module 212 may be configured to generate instructions to, when provided to a robotic device, cause that robotic device to traverse the grow operation to an area to be scouted and confirm or disprove the existence of the determined condition within that area. In some embodiments, this entails generating a path throughout the area which will be tested by the robotic device to detect the presence of the condition. For example, given that a potential fungal infection is detected within an area, a UAV may be scheduled to fly through the area capturing images of plants throughout the UAV's path. In this example, the images may be analyzed to determine if the detected fungal infestation is actually present. Once the area has been scouted and the condition is either confirmed or disproved, the scouting management module 212 may be configured to cause the robotic device to return to a base of operation (e.g., a UAV dock). In some embodiments, the scouting management module 212 may use one or more path planning algorithms to define a flight path for a UAV that is scouting an area based on the known locations of plants, terrain obstacles, greenhouse environmental features or objects, and/or other objects in the areas. Such locations may be stored in an area profile database accessible to the scouting management module 212. The flight path may be defined such that at least every plant in the area is observed by the sensors and cameras of the UAV. For example, such path planning algorithms may include a Frank-Wolfe heuristic algorithm, a heat map distribution algorithm, an equilibrium assignment algorithm, a multivariant optimization model algorithm, or other machine learning algorithms.

The horticultural management device 126 may be any suitable computing device configured to present information to one or more users. In some embodiments, the horticultural management device 126 may include a display screen capable of presenting information to a user in the form of a graphical user interface (GUI). In some embodiments, the GUI may be implemented upon execution of a mobile application 234 that facilitates interaction between the horticultural management device 126 and the central computing device 112 and/or service platform 116. Such interaction may be enabled via a communication interface 236 of the horticultural management device 126. In alternative embodiments, the mobile application 234 may be substituted with a desktop application that executes on a computing device with a larger form factor than the horticulture management device 126, such as a laptop computer, a desktop computer, a server, etc. The larger form factor computing device may perform the same functionalities as the mobile application 234.

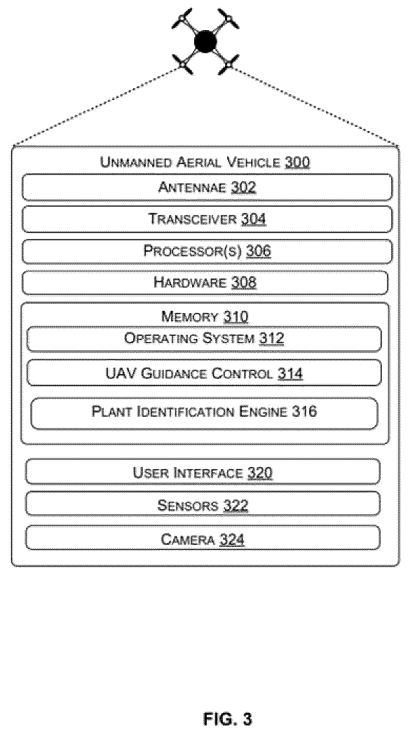

FIG. 3 illustrates an example of an unmanned aerial vehicle 300 for use in horticultural operations as provided herein. The unmanned aerial vehicle 300 may operate with a ground-based air traffic control (ATC) system. The unmanned aerial vehicle 300 may include, among other components, one or more antennas 302, a transceiver 304, one or more processors 306, hardware 308, and memory 310. In some embodiments, the antennas 302 include an uplink antenna that sends radio signals to one or more other UAVs. In addition, there may be a downlink antenna that receives radio signals from the one or more other UAVs. In other embodiments, a single antenna may both send and receive radio signals. These signals may be processed by a transceiver 304 that is configured to receive and transmit data.

The UAV 300 may include one or more processors 306, which may be a single-core processor, a multi-core processor, a complex instruction set computing (CISC) processor, or another type of processor. The hardware 308 may include a power source and digital signal processors (DSPs), which may include single-core or multiple-core processors. The processors may perform an operation in parallel to process a stream of data that may be provided by various sensors 322.

The hardware 308 may also include network processors that manage high-speed communication interfaces, including communication interfaces that interact with peripheral components. The network processors and the peripheral components may be linked by switching fabric. The hardware 308 may further include hardware decoders and encoders, a network interface controller, and/or a universal serial bus (USB) controller.

In various embodiments, the UAV 300 may include various integrated sensors. For example, a sensor may be one that is built into the sensor device 108. In various embodiments, the sensors 322 of the UAV 300 may include a LIDAR system to determine a position of the UAV and/or to monitor the environment in which the UAV is operating. The unmanned aerial vehicle 300 may also comprise a camera 324 to capture images of the grow operation according to a field of view. The capture images may include visible light images, infrared images including near infrared images, and hyperspectral images. In one example, the camera 324 is a wide-angle camera to capture a large field of view. In this example, the images captured by the camera 324 may be divided into multiple sub-pictures, where the sub-pictures are processed separately.

The memory 310 may be implemented using computer-readable media, such as computer storage media. Storage media includes volatile and non-volatile, removable and non-removable media implemented in any suitable method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition video storage disks, or other optical storage, magnetic cassettes, magnetic tape, magnetic disk storage or other the memory may be implemented using computer-readable media, such as computer storage media. Storage media includes volatile and non-volatile, removable and non-removable media implemented in any suitable method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high definition video storage disks, or other optical storage, magnetic cassettes, magnetic tape, magnetic disk storage or other magnetic storage devices, or any other non-transmission medium that can be used to store information for access by a computing device.

The memory 310 may store various software components that are executable or accessible by the processor(s) 306. The various components of the memory 310 may include software and an operating system 312. Each module may include routines, program instructions, objects, and/or data structures that perform particular tasks or implement particular abstract data types.

The software may enable the unmanned aerial vehicle 300 to perform functions to guide UAVs and control hardware components, including the sensors 322 and camera 324. In various embodiments, the software may provide various functions, such as directly or indirectly instructing the UAV 300 to change its position, when to trigger the capture of an image of a plant, and/or so forth.

The UAV guidance control 314 is configured to generate one or more navigation/control commands to the flight controls and/or propulsion systems of the UAV 300. The navigation commands may include commands to control thrust, yaw, pitch, roll, etc., of the UAV 300 such that the UAV 300 follows the predefined path. The predefined path can be within a grow operation or across multiple grow operations. In this way, the UAV 300 can navigate from one operation zone to another operation zone. The UAV guidance control 314 may perform obstacle or collision avoidance as the UAV 300 follows a predefined path provided by the scouting management module 212. For example, the obstacle or collision avoidance may include applying reactive control laws to steer the UAV 300 around an obstacle that is detected by the sensors 322 or the camera 324. Once the obstacle is cleared, the UAV guidance control 314 may cause the UAV to resume the predefined path.

In some embodiments, the UAV 300 may include a plant identification engine 316 that is configured to enable identification of one or more plants in proximity to the unmanned aerial vehicle. In other words, the unmanned aerial vehicle 300 may be capable of performing plant identification/classification functions. In these embodiments, the UAV 300 may perform the plant identification functions and transmit the results of those plant identification functions to the service platform. Such plant identification information may be provided along with location information (e.g., a location at which the image of the plant was captured).

It should be noted that while FIG. 3 depicts an unmanned aerial vehicle, one skilled in the art would recognize that alternatives may provide for equivalent functionality. For example, the vehicle may be a stationary robotic device, a robotic device that is transported via rails or other suitable greenhouse infrastructure including scaffolding, structural beams, lighting structures and pipes such as heating pipes, a grounded unmanned vehicle, or an affixed robotic device that is attached to another piece of mobile equipment that is able to move around a greenhouse. For example, the ground unmanned vehicle may be a wheeled or tracked vehicle that is able to traverse the ground while being able to avoid obstacles that are present on the ground in a similar manner as the UAV. In another example, the affixed robotic device may be attached to a watering boom that is configured to water the plants in an area or other suitable greenhouse mobile infrastructure elements such as sprayers. Thus, as the watering boom is moved around the area, the affixed robotic device is able to move and use its sensors and cameras to obtain samples and readings for the area. Such embodiments should be considered equivalents for the purposes of this disclosure. In another example, the vehicle may be a horticultural management device or other suitable mobile device operated by an agent/employee of the grow operation. In this example, the agent/employee may capture images throughout the grow operation and/or carry out instructions provided to the horticultural management device. Furthermore, in some embodiments, the various mobile devices may be implemented in conjunction with stationary devices that are sparsely distributed throughout an area. For example, the stationary devices may be distributed at regular intervals in a grid pattern to cover the area. Such stationary devices may be equipped with similar sensors and cameras as the mobile devices. Thus, these stationary devices are capable of collecting data values via sensors and cameras in the same manner as the mobile devices. In some instances, these stationary devices may be used to gather historical or supplemental data values that correlate with certain conditions, such that these values may be used to trigger scouting by robotic devices in the form of mobile devices. In other instances, the historical or supplemental data values gathered by the stationary devices may be used to establish or refine attribute data value ranges associated with the occurrence of conditions. Alternatively, or concurrently, the historical or supplemental values gathered by the stationary devices may be used in combination with other data to train various types of machine learning models to recognize the occurrence of conditions.

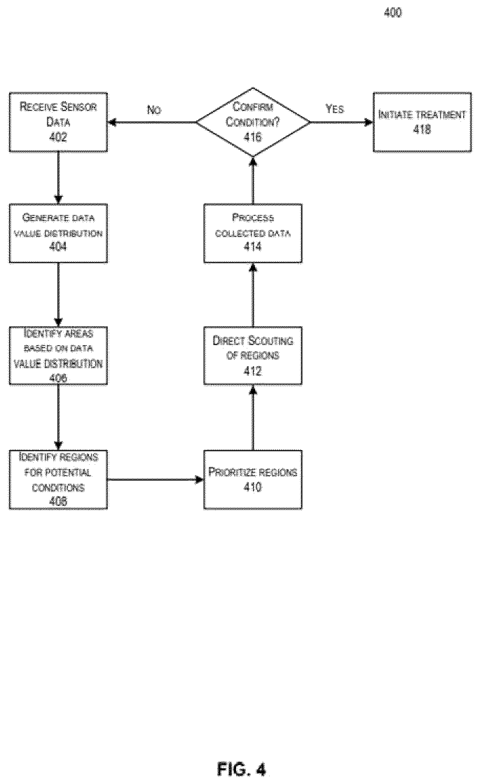

FIG. 4 depicts a block diagram illustrating an example process for monitoring and checking for conditions in a grow operation in accordance with at least some embodiments. Process 400 is depicted as a series of blocks, each block representing a sequence of actions. The process 400 can be performed in any suitable system, including but not limited to growth optimization system 100 shown in FIG. 1.

At 402, the process 400 may involve receiving sensor data from a number of sensors distributed throughout a grow operation. The sensors may include a variety of different types of sensors each of which is configured to collect information about an environment associated with the grow operation. For example, temperature sensors may collect (and relay) data values representative of temperatures collected at particular locations throughout the grow operation. In parallel, humidity sensors may collect (and relay) data values representative of humidity collected at particular locations (which may be the same or different locations as temperature data was collected from) throughout the grow operation. In this example, each of the received temperature data and humidity data may be separately or jointly associated with respective locations throughout the grow operation.

At 404, the process 400 may involve generating one or more current (or latest) distributions of data values to be associated with the grow operation. Such a distribution of data values may include any suitable association between a plurality of data values and locations throughout the grow operation. In some cases, where a data value is not available for a particular location (e.g., there is no sensor at the location), then a data value may be calculated for that location by extrapolating based on other data values. For example, temperature data may be collected for two locations, Point A and Point B. In this example, each of Point A and Point B may be associated with the respective collected temperature data values within a data value distribution. Additionally, a data value may be calculated for each point between Point A and Point B based on a relationship between that point (e.g., distance between) and one or both of Point A and Point B.

In some cases, a calculation of one or more data values may be made using a formula or algorithm. For example, data values for each point may be calculated as a function (e.g., a linear function) of its position with respect to Point A and/or Point B as well as their respective data values. It should be noted that while an example is provided in which a data value may be extrapolated for a point based on a relationship between that point and two other points, such a data value may be extrapolated based on any suitable number of points and using any suitable data extrapolation means.

At 406, the process 400 may involve identifying one or more potential conditions to be associated with a region or area within the grow operation based on the distribution data. For example, a set of attribute data value ranges may first be identified as being associated with each condition to be detected. For each of the attribute data value ranges associated with a condition, areas of the grow operation may be identified as having data values falling within the range of values based on the data value distribution for the respective attribute.

By way of example, given that a condition to be detected is a particular fungal infestation, a set of attribute data value ranges may be identified that represent conditions in which the fungal infestation could, or typically would, manifest. In this example, the set of attribute data value ranges may include at least a range of humidity data values, a range of temperature data values, a range of lighting data values, a range of soil acidity data values, and a range of plant types. In this example, a number of areas may be identified for each of the respective attributes within the grow operation over which the data values are within the respective ranges.

Once a number of areas have been identified for each of the attributes in the set of attribute data value ranges, areas of overlap between each of the attributes may be identified as regions for a potential condition at 408. For example, a region may be identified that represents an area for which all current data values (according to the respective data value distributions) falls within the respective attribute data value ranges. In some cases, regions for a potential condition may include only those areas of overlap for which all of the data values fall within their respective ranges. Alternatively, or in addition, the one or more potential conditions to be associated with a region or area within the grow operation may be identified with a machine learning model.

At 410, the process 400 may involve determining an order of priority for scouting the identified regions. In some embodiments, the order of priority may be determined based on a priority assigned to each of the respective conditions associated with each region. For example, some conditions may be assigned a higher priority than others because of a level of destructiveness associated with the condition and/or a speed at which the condition may develop. In some embodiments, the order of priority may be determined based on one or more attributes of various plants impacted by the detected condition. For example, the order of priority may be assigned based on a type of plant or plants in that area, a current lifecycle stage of the plant or plants, a value (e.g., a dollar value) of the plant or plants, or any other suitable factor.

At 412, the process 400 may involve directing scouting of the identified regions to confirm or disprove the condition within the region. In embodiments, one or more robotic devices, such as UAVs, may be identified as being able to provide scouting to the region. In some cases, a robotic device may be selected for scouting because of its proximity to the region to be scouted. For example, UAV docks may be identified based on their proximity to the region to be scouted and a UAV may be selected by virtue of being docked in one of the UAV docks. In some cases, a robotic device may be selected for scouting because of one or more capabilities of that robotic device. For example, a robotic device may be selected because of its ability to capture high resolution images. In another example, diagnosing a condition may require collecting samples of a plant and the robotic device may be selected for its capability to collect such a sample. In some cases, a robotic device may be selected based on a current level of battery charge and the ability of the robotic device to complete the scouting task. It should be noted that while several examples of selection factors are provided herein, any suitable combination of factors may be used to select a robotic device to perform a scouting operation.

Once one or more robotic devices have been selected to perform a scouting operation, instructions may be provided to those robotic devices to cause them to perform the scouting. In some cases, a route may be generated and provided to the robotic device to guide the robotic device in the scouting operation. In some embodiments, confirmation of a condition may require capturing images of one or more plants within the specified region. In these embodiments, the robotic device may be provided instructions to cause it to traverse the region and capture (continuously, periodically, or at fixed intervals) images of plants (or portions thereof) within the region. In some embodiments, depending on the condition to be detected, the robotic device may be further instructed to use a particular type of lighting or image capture device (e.g., ultraviolet or infrared). In some embodiments, confirmation of a condition may require collection of one or more samples or readings. For example, with respect to temperature, the robotic device may be instructed to use an air temperature sensor to capture ambient temperature readings around a set of plants and use an infrared sensor to capture the leaf surface temperatures of leaves of the plants. In these embodiments, the robotic device may be provided instructions to cause it to traverse the region and collect samples and/or readings (e.g., temperature readings or soil acidity readings) throughout the region. In some cases, the samples or readings may be collected from random locations/plants within the region. In some cases, the samples or readings may be collected from specific locations or at predetermined intervals (e.g., from a specified plant or at points at a predetermined distance).

At 414, the process 400 may involve processing data collected by the robotic device while scouting the region. In some cases, this may involve the use of one or more image processing techniques as well as one or more machine learning algorithms (e.g., a trained machine learning model) configured to detect the condition within one or more images and/or sensor data. In some cases, the collected data may be processed at 414 by a backend system, such as the service platform 116 described in relation to FIG. 1 and FIG. 2 above. In some cases, the collected data may be processed onboard by the robotic device to detect the condition with the one or more images and/or sensor data as the robotic device scouts the region (e.g., in real time).

At 416, the process 400 may involve determining whether or not the condition is present within the region based on the analysis conducted above. In the above cases, a condition may be confirmed for the region upon verifying that the condition is depicted in one or more of the collected images. In contrast, the existence of the condition within the region may be disproven upon failing to verify that the condition is depicted in one or more of the collected images.

Upon determining that the condition is present (e.g., “Yes” from decision block 416), the process 400 may involve initiating a treatment process. Such a treatment process may be specific to the condition detected. For example, provided that the condition is a disease, initiating a treatment may involve administering an antidote or remedy to the plants within the region. In this example, the robotic device (or another robotic device) may be deployed with the antidote or remedy in order to apply it to the affected plants. In some embodiments, initiating treatment may involve providing a notification to a user regarding the condition. For example, a notification may be generated and provided to a horticultural management device (e.g., horticultural management device 126 of FIG. 2) to be presented to a user.

The step of initiating treatment of the condition may be executed with or without instructions from a user. For example, in some cases a notification may be presented to a user with a proposed treatment plan. Upon receiving approval from the user, the treatment plan may be executed. In another example, a treatment plan may be executed automatically (e.g., without human intervention). This may be done by providing instructions to an automated system (e.g., a sprinkler system, a lighting system, a robotic device, etc.) to take action intended to remedy the condition.

Upon determining that the condition is not present (e.g., “No” from decision block 416), the process 400 may involve returning the robotic device to its docking station and continuing to monitor for various conditions.

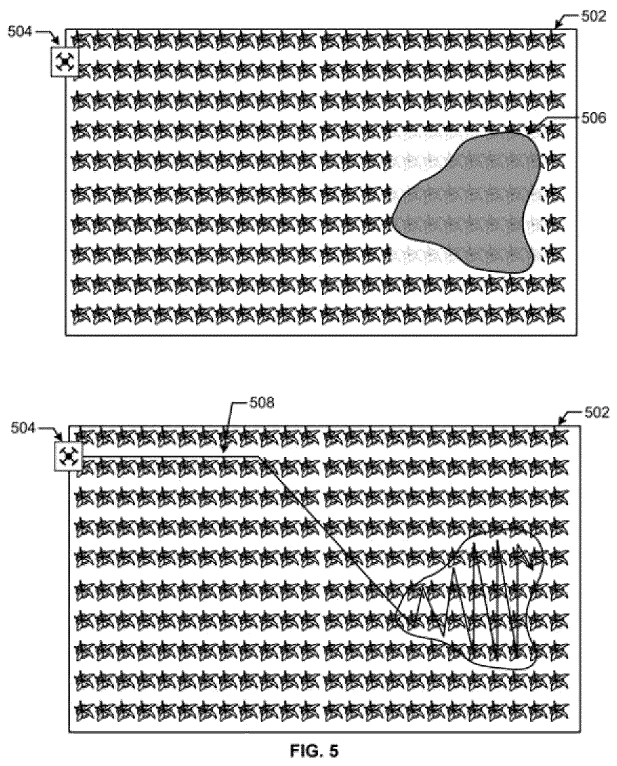

FIG. 5 depicts a graphical illustration of a process for identifying a region of a grow operation and performing a data gathering operation of that region in accordance with at least some embodiments. As noted elsewhere, a grow operation 502 may include a predetermined area that contains a number of plants. Additionally, a grow operation may include a number of sensors distributed throughout the grow operation, a number of automated systems configured to service the plants (such as automated sprinkler systems, automated lighting systems, humidity/temperature control systems, etc.) as well as one or more UAV docks 504 that act as a base of operations for at least one robotic device.

As noted elsewhere, sensor data may be obtained from a variety of different types of sensors. Based on the received sensor data, current data values for a number of attributes may be calculated based on the received sensor data and associated with locations within the grow operation from which the respective sensor data was received. One or more regions 506 may then be identified as being potentially associated with a condition, for example, upon determining that each of the attribute data values within the region 506 are within a respective data value range associated with the condition and/or using a machine learning model.

Once such a region 506 has been identified, one or more robotic devices in UAV dock 504 may be provided instructions to execute a scouting operation in order to determine whether the condition is present. The scouting operation may include instructions that cause the robotic device to traverse the region 506 and make a determination as to whether or not the condition is present within that region. In some cases, this may involve capturing images of the plants or environment within the region 506 and assessing (e.g., using machine vision techniques and machine learning) whether those images depict the condition. If the robotic device is able to detect the condition during the scouting operation, then the condition is confirmed. If the condition is not detected, a determination may be made that the condition is not currently present.

By way of example, consider a scenario in which a determination is to be made as to whether a fungal infestation may be present within the grow operation. In this example, the fungal infection may be one that develops in environments that contain 70-85% humidity, a temperature in the range of 65-85%, and an illuminance (i.e., light level) of less than 800 lux. In this example, regions within the grow operation may be identified where the determined current attribute values are within those ranges.

In some cases, various conditions may not develop right away. For example, the fungal infestation exemplified above may have a gestation period of two weeks. In these cases, the one or more regions may be identified where the data values have been within the respective data value ranges for at least a predetermined amount of time. In some cases, certain conditions may only affect particular plant types. In these cases, region 506 may only be identified where it includes such plant types.

In some embodiments, once a condition has been confirmed, a treatment of that condition may be initiated. In some cases, this may involve providing instructions to one or more robotic devices to cause it to apply a remedy to the condition. In some cases, an indication of which remedies are effective for each condition may be maintained by the service platform. In some cases, initiating treatment of a condition may involve providing a notification of the condition to a user device (e.g., the horticultural management device 126 of FIG. 2). In some cases, the notification may also include a recommended treatment, one or more images of the condition, and/or a location of the condition. As further described below, the initiation of treatment may be followed by additional check-ins of the area affected by the condition to determine whether the area is still affected by the condition after the treatment has been implemented. In such embodiments, a remedy module of the service platform 116 may receive an indication that is inputted via a user interface of a computer (e.g., a mobile application of a mobile computing device) that a remedy has been performed. In turn, the remedy module of the service platform 116 may automatically initiate a scouting of the area by a robotic device. Alternatively, the module may initiate the scouting by prompting the grower via the user interface and receive an affirmative input to proceed in return from the grower. If the condition is assessed to be still present after the implementation of the treatment, the same remedy or another remedy may be implemented. Subsequently, another scouting may be initiated by the remedy module of the service platform 116 for the area. In this way, these scouting and remediation steps may be repeated iteratively to provide multiple remedies and multiple check-ins for the same area.

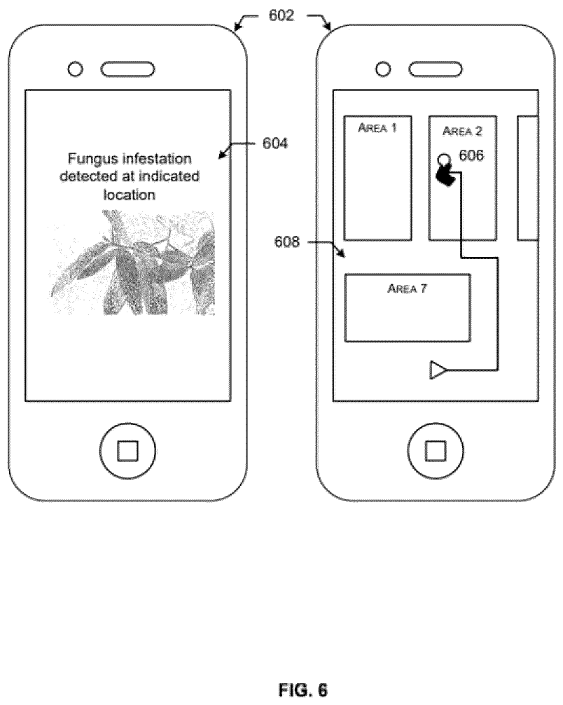

FIG. 6 depicts examples of information that may be presented via a graphical user interface implemented in accordance with at least some embodiments. As noted elsewhere, a service platform as described herein may provide information to a user device 602 (e.g., a horticultural management device as described elsewhere). The information provided to the user device may be presented via a GUI associated with the service platform.

In some embodiments, the information provided to the user device and presented to a user via a GUI may include a notification 604. In some embodiments, such a notification may be accompanied by information about the condition (e.g., a location of the condition) and/or instructions for addressing the condition.

In some embodiments, the information provided to the user device and presented to a user via a GUI may include an indication of a location 606 associated with a detected condition as well as instructions on traversing to that location. In some embodiments, the GUI may provide access to a map 608 of an area or region that includes the grow operation at which the condition has been detected.

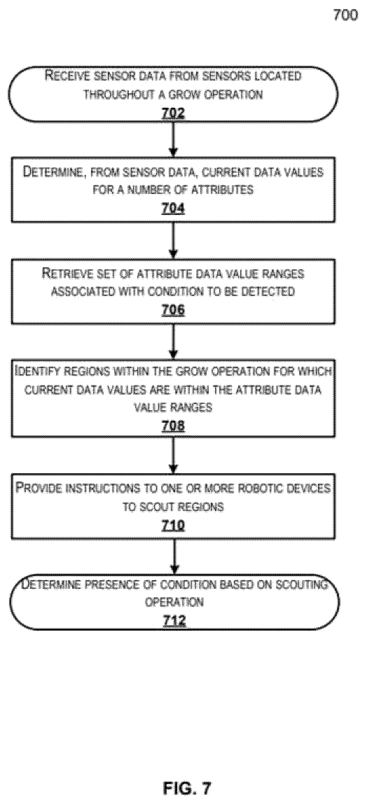

FIG. 7 depicts a flow diagram illustrating a process for providing automated scouting of regions to detect various conditions in accordance with at least some embodiments. In accordance with embodiments, the process 700 may be performed by various components of the system described with respect to FIG. 1, such as the sensor devices 108, UAV docks 110, a service platform 116 and/or a horticultural management device 126.

At 702, the process 700 involves receiving sensor data from a number of sensors located within a grow operation. In embodiments, the number of sensors are distributed throughout the grow operation. Sensors may provide sensor data either continuously or at periodic intervals. Sensor data provided periodically may be provided at any suitable frequency.

At 704, the process 700 involves determining, from the received sensor data, current data values for a number of attributes. In some embodiments, the sensors include at least one of a temperature sensor, light sensor, pH sensor, humidity sensor, or CO₂ sensor. In some embodiments, the sensors include at least one image capture device (e.g., a camera). In some embodiments, the at least one image capture device may be installed within a robotic device configured to traverse the grow operation, such as a UAV that is configured to fly along a route within the grow operation.

At 706, the process 700 involves retrieving a set of attribute data value ranges associated with a condition to be detected. The condition may include any suitable status applicable to one or more plants within the grow operation. In some embodiments, the condition comprises a disease, infection, infestation, or a lifecycle stage of a plant. Each condition to be detected may be associated with a different set of attribute data value ranges that represent environmental conditions that are indicative of the condition.

At 708, the process 700 involves identifying regions within the grow operation for which the current data values are within the retrieved data value ranges. In some embodiments, the one or more regions are identified if the current data values have remained within the respective attribute data value ranges of the set of attribute data value ranges for at least a predetermined amount of time. Alternatively, or in addition, the regions may be identified with a machine learning model based on the current data values. In some embodiments, the one or more regions are identified if a plant type located within the one or more regions is a plant type that is affected by the condition.

At 710, the process 700 involves providing instructions to one or more robotic devices to scout the identified regions. In some embodiments, the robotic device comprises an unmanned aerial vehicle. In some embodiments, the instructions provided to the one or more robotic devices may include instructions to traverse the identified regions and collect information from those regions. In alternative instances, the scouting of one or more regions by the one or more robotic devices may be triggered without regard to the current data values. For example, as discussed above, the scouting of a region may be manually initiated by a grower, by the presence of environmental features in the region, by the performance of one or more tasks in the region, by historical data on the occurrence of a condition in the region, and/or so forth.

At 712, the process 700 involves determining whether the condition is present in the identified regions. In some embodiments, the condition may be determined to be present in the one or more regions upon detecting at least one symptom of the condition within one or more images collected by the robotic device during the scouting operation. In these embodiments, the at least one symptom of the condition is detected using a machine learning model. Alternatively, the condition may be determined not to be present in the one or more regions upon failing to detect at least one symptom of the condition within one or more images collected by the robotic device during the scouting operation.

In some embodiments, upon determining that the condition is present in the identified region or regions, the process 700 may involve the performance of additional actions. For example, the process may involve providing a notification of the condition to one or more user device (e.g., a horticultural management device). In some embodiments, such a notification may include at least one of a recommended treatment for the condition, one or more images of the condition, or a location of the condition. In a second example, the process may involve initiating a treatment procedure for the condition. In some cases, this may mean activating one or more automated systems, to include at least one of a sprinkler system, a lighting system, a humidity control system, or a temperature control system. In some cases, initiating a treatment procedure for the condition may include providing instructions to a second robotic device to cause it to administer a remedy to plants in the one or more regions. In additional cases, following the administration of the remedy, additional instructions may be provided by the service platform to the second robotic device or another robotic device to cause the device to perform an additional scouting operation of the one or more regions to determine whether the condition is still present. For example, if the condition is chlorosis that causes the yellowing of the plants, the remedy administered may be the spraying of the plants with fungicide or bactericide. Following the spraying of the plants, the additional scouting operation may be performed to assess whether the chlorosis has disappeared. In another example, if the condition is the presence of a specific species of harmful bugs among the plants that is above a predetermined population threshold, the remedy may be the spraying of the plants with pesticide. Following the spraying of the plants, the additional scouting may be performed to assess whether a population of the harmful bugs is no longer above the predetermined population threshold. In other words, the additional scouting operation may be performed to determine whether the remedy is effective. Thus, if the remedy is not effective, further instructions may be provided to the second robotic device or another robotic device to cause the device to administer another course of remedy or an alternative remedy. In some cases, such remedy administration and additional scouting may be performed iteratively for multiple times.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving sensor data from a number of sensors within a grow operation;
determining current data values for a number of attributes based on the sensor data, the current data values associated with locations within the grow operation;
identifying, based at least in part on one or more pre-trained machine learning (ML) models, one or more regions within the grow operation potentially associated with a condition;
providing instructions to at least one robotic device to perform a data gathering operation of the one or more regions; and
determining, based at least in part on information collected during the data gathering operation and the one or more pre-trained ML models, whether the condition is present in the one or more regions.

2. The computer-implemented method of claim 1, wherein the robotic device comprises an unmanned aerial vehicle (UAV) or is incorporated into the UAV.

3. The computer-implemented method of claim 1, wherein the data gathering operation comprises at least one of: (i) a scouting operation, and (ii) a crop registration operation.

4. The computer-implemented method of claim 1, wherein the number of sensors comprise at least one of a temperature sensor, light sensor, pH sensor, humidity sensor, image sensors, or CO₂ sensor.

5. The computer-implemented method of claim 1, wherein the number of sensors comprise at least one image capture device.

6. The computer-implemented method of claim 5, wherein the at least one image capture device is installed within a second robotic device configured to traverse the grow operation.

7. The computer-implemented method of claim 1, wherein the condition comprises a disease, infection, infestation, or a lifecycle stage of a plant.

8. The computer-implemented method of claim 1, wherein the condition is determined to be present in the one or more regions upon detecting at least one symptom of the condition within one or more images collected by the robotic device during the data gathering operation.

9. The computer-implemented method of claim 1, wherein the detecting is further based at least in part on an external weather condition including at least one of: hours of sunlight, time of sunrise, time of sunset, cloudiness, average temperature, average low temperature and average high temperature.

10. A computing device comprising:
a processor; and
a memory including instructions that, when executed with the processor, cause the computing device to, at least:
receive sensor data from a number of sensors within a grow operation;
determine current data values for a number of attributes based on the sensor data, the current data values associated with locations within the grow operation;
identify, based at least in part on one or more pre-trained machine learning (ML) models, one or more regions within the grow operation potentially associated with a condition;
provide instructions to at least one robotic device to perform a data gathering operation of the one or more regions; and
determine, based at least in part on information collected during the data gathering operation and the one or more pre-trained ML models, whether the condition is present in the one or more regions.

11. The computing device of claim 10, wherein the instructions further cause the computing device to, upon determining that the condition is present, provide a notification of the condition to one or more user device.

12. The computing device of claim 11, wherein the notification comprises at least one of a recommended treatment for the condition, one or more images of the condition, or a location of the condition.

13. The computing device of claim 10, wherein the instructions further cause the computing device to, upon determining that the condition is present, initiate a treatment procedure for the condition.

14. The computing device of claim 13, wherein initiating the treatment procedure for the condition comprises activating one or more automated systems.

15. The computing device of claim 14, wherein the one or more automated systems comprise at least one of a sprinkler systems, a lighting system, a humidity control system, or a temperature control system.

16. The computing device of claim 13, wherein initiating the treatment procedure for the condition comprises providing instructions to a second robotic device to cause it to administer a remedy to plants in the one or more regions.

17. The computing device of claim 16, wherein the instructions further cause the computing device to, following the administer of the remedy, perform an additional data gathering operation of the one or more regions to determine whether the condition is still present.

18. A non-transitory computer-readable media collectively storing computer-executable instructions that upon execution cause one or more computing devices to collectively perform acts comprising:
receiving sensor data from a number of sensors within a grow operation;
determining current data values for a number of attributes based on the sensor data, the current data values associated with locations within the grow operation;
identifying, based at least in part on one or more pre-trained machine learning (ML) models, one or more regions within the grow operation potentially associated with a condition;
providing instructions to at least one robotic device to perform a data gathering operation of the one or more regions; and
determining, based at least in part on information collected during the data gathering operation and the one or more pre-trained ML models, whether the condition is present in the one or more regions.

19. The non-transitory computer-readable media of claim 18, wherein the one or more regions are identified if the current data values have remained within respective attribute data value ranges of a set of attribute data value ranges for at least a predetermined amount of time.

20. The non-transitory computer-readable media of claim 18, wherein the one or more regions are identified if a plant type located within the one or more regions is a plant type that is affected by the condition.
